(19) United States
(12) Patent Application Publication
(10) Pub. No.: US 2019/0340841 A1
(43) Pub. Date: Nov. 7, 2019

(54) COMPUTING SYSTEM FOR DEFINING AND PROVIDING ACCESS TO A PARKING AREA

(71) Applicant: SIMPLYPARK LTD., University Heights, OH (US)

(72) Inventors: Michael Coyne, University Heights, OH (US); Thomas Coyne, University Heights, OH (US)

(21) Appl. No.: 15/972,720

(22) Filed: May 7, 2018

(51) Int. Cl. G07B 15/02; G06Q 20/32; H04L 29/08; H04W 4/02

(52) U.S. Cl. CPC G07B 15/02; G06Q 20/322; G06Q 2240/00; H04W 4/023; H04L 67/18

(57) ABSTRACT

A server computing device receives a set of geolocation coordinates and an identifier for a parking provider from a first mobile computing device operated by the parking provider. The set of geolocation coordinates define a parking area under control of the parking provider. Subsequently, the server computing device receives an identifier for a driver and geolocation coordinates from a second mobile computing device operated by the driver. The driver operates a vehicle and the geolocation coordinates reflect a position of the vehicle within the set of geolocation coordinates. The server computing device then identifies a parking provider account for the parking provider based upon the geolocation coordinates and the set of geolocation coordinates. The server computing device also identifies a driver account for the driver based upon the identifier for the driver. The server computing device causes credits to be transferred from the driver account to the parking provider account.

### BACKGROUND

Computer-executable parking applications may be used by parking lot providers and drivers in order to facilitate parking of vehicles operated by the drivers in parking lots under control of the parking lot providers. An exemplary parking application executing on a computing device of a parking lot provider may receive input causing a parking lot under control of the parking lot provider to be registered with the parking application.

Subsequently, a driver may park a vehicle under his or her control in the parking lot. The parking application may receive data indicating that the vehicle has entered the above-referenced parking lot. For instance, a computing device operated by the driver may receive input from the driver causing the computing device to transmit an indication to the parking application that the vehicle has been parked in the parking lot.

When the driver returns to the vehicle, starts the vehicle, and causes the vehicle to exit the parking lot, the computing device operated by the driver may receive further input from the driver causing the computing device to transmit a second indication to the parking application that the vehicle has exited the parking lot. The parking application may then calculate a charge that is to be credited against the driver and charge the driver for time spent by the vehicle in the parking lot.

Conventional parking applications suffer from various drawbacks. First, conventional parking applications require at least some input on behalf of the driver in order for the driver to properly park the vehicle. Second, conventional parking applications do not provide functionality that enable a parking lot provider to define individual parking areas.

### SUMMARY

The following is a brief summary of subject matter that is described in greater detail herein. This summary is not intended to be limiting as to the scope of the claims.

Described herein are various technologies pertaining to defining and providing access to parking areas. More specifically, a computer-executable parking application is described herein, wherein the parking application is a distributed application that includes server-side functionality (server parking application) and client-side functionality. The client-side functionality includes functionality for parking area providers that provide parking areas (parking provider application), as well as functionality for drivers who cause vehicles to be parked in the parking areas (driver parking application).

The parking application enables a parking provider to define a parking area using geo-motion detection components comprised by a computing device operated by the parking provider. The geo-motion detection components are generally configured to detect a geographic position of the computing device and/or a velocity (i.e., speed and direction) of the computing device. For instance, the geo-motion detection components may include one or more of a global position system (GPS) receiver, an assisted GPS receiver, a gyroscope, a magnetometer, an accelerometer, a compass, a barometer, an altimeter, a radio frequency transreceiver, or a motion coprocessor. The geo-motion detection components may also interface with cellular towers in order to detection position and/or velocity of the computing device. The parking application additionally detects when a vehicle operated by a driver enters and exits the parking area. The parking application also facilitates exchange of credits from drivers to parking providers as compensation for parking in the parking area.

In operation, a parking provider application executing on a parking provider computing device (e.g., a mobile computing device such as a smartphone) operated by a parking provider ascertains a set of geolocation coordinates (e.g., one or more latitude and longitude measurement pairs) using the geo-motion detection components (e.g., an assisted GPS receiver) comprised by the parking provider computing device. For instance, an assisted GPS receiver may have an accuracy of 1-50 cm, meaning that the geolocation coordinates provided by the assisted GPS receiver differ from actual geolocation coordinates of the parking provider computing device by no more than 1-50 cm within a certain threshold percentage (e.g., 95%) of time.

The set of geolocation coordinates define a parking area that is under control of the parking provider. In a specific example, the geo-motion detection components of the parking provider computing device may include an assisted GPS receiver, and the assisted GPS receiver may receive data from GPS satellites as the parking provider moves the parking provider computing device across boundaries of the (to be defined) parking area. The assisted GPS receiver may ascertain the set of geolocation coordinates based upon the data. The set of geolocation coordinates may also be determined in part by other geo-motion detection components of the parking provider computing device. In another specific example, the parking provider computing device may present a map of an area surrounding the parking provider computing device on a touchscreen of the parking provider computing device. The parking provider can drag a pin onto an area of the map where the parking area is to be defined, and the parking provider computing device can ascertain the set of geolocation coordinates based on a location of the pin on the map. The parking area may be a parking space in a commercial parking lot under control of the parking provider, a parking space in a driveway or yard under control of the parking provider, or a street-parking space under control of the parking provider.

Optionally, the parking provider computing device may receive input indicative of an amount of credits that are to be charged to a driver that parks his or her vehicle in the parking area. For instance, the amount may be a fixed amount, an hourly amount, or an amount that is calculated based upon demand for nearby parking areas at a given time.

Subsequently, the parking provider computing device transmits the set of geolocation coordinates and an identifier for the parking provider to a server computing device executing a server parking application. The server computing device is in network communication with the parking provider computing device. Optionally, the parking provider computing device may transmit the amount to be charged to the server computing device as well. Responsive to receiving the set of geolocation coordinates and the identifier for the parking provider, the server computing device may identify a parking provider account for the parking provider based upon the identifier for the parking provider. The server computing device may also store the set of geolocation coordinates in association with the parking provider account in a data store comprised by the server computing device.

Sometime thereafter, it is contemplated that a driver is operating or is a passenger in (i.e., driving) a vehicle (e.g., an automobile). It is further contemplated that the driver possesses a driver computing device (e.g., a mobile computing device such as a smartphone) that is on his/her person while the driver operates or is a passenger in the vehicle. Alternatively, the driver computing device may be integrated into the vehicle itself. The driver computing device executes a driver parking application. The driver computing device is in network communication with the server computing device.

In an embodiment, the driver computing device may receive input from the driver causing the driver computing device to transmit a request for an available parking area to the server computing device. The request comprises geolocation coordinates (i.e., a latitude and longitude measurement pair) reflecting a current position of the vehicle. The driver computing device may ascertain the geolocation coordinates for the current position of the vehicle using the geo-motion detection components comprised by the driver computing device. Responsive to receiving the request from the driver computing device, the server computing device may identify the (above-referenced) parking area based upon the geolocation coordinates and the set of geolocation coordinates retained in the data store. The server computing device may then cause the driver computing device to receive directions from the current position of the vehicle to the parking area (e.g., by way of an Internet-based mapping service).

The driver may then drive the vehicle to the parking area, park the vehicle in the parking area, and exit the vehicle. The driver computing device can be configured to automatically detect that the vehicle has been parked without input from the driver using geo-motion detection components comprised by the driver computing device. For instance, the geo-motion detection components may include an accelerometer and a motion coprocessor. The motion coprocessor may receive data from the accelerometer, and the motion coprocessor may determine whether the vehicle is parked based upon the data received from the accelerometer.

Responsive to determining that the vehicle is parked, the driver computing device ascertains geolocation coordinates for the (parked) vehicle using the geo-motion detection components, wherein the geolocation coordinates reflect a position of the vehicle within the (above-described) set of geolocation coordinates. For instance, an assisted GPS receiver of the driver computing device (as well as potentially other geo-motion detection components) may receive data from space-based satellites, and the assisted GPS receiver may ascertain the geolocation coordinates for the vehicle based upon the data. Responsive to ascertaining the geolocation coordinates, the driver computing device may transmit the geolocation coordinates and an identifier for the driver to the server computing device.

Responsive to receiving the geolocation coordinates and the identifier for the driver from the driver computing device, the server computing device identifies a parking provider account based upon the geolocation coordinates and the set of geolocation coordinates. More specifically, the server computing device determines that the geolocation coordinates fall within an area (i.e., the parking area) defined by the set of geolocation coordinates retained in the data store of the server computing device. The server computing device may also record a first date-time, wherein the first date-time is reflective of a date and time at which the vehicle was parked in the parking area. The server computing device may additionally mark the set of geolocation coordinates (i.e., the parking area) retained in the data store as occupied so that other vehicles are not routed to the parking area while the parking area is occupied by the vehicle. The server computing device may also verify that the parking provider has authority to use the area defined by the set of geolocation coordinates.

The server computing device also identifies a driver account for the driver based upon the identifier for the driver. For instance, the server computing device may execute a search over driver accounts retained in the data store based upon the identifier for the driver. The search produces search results, wherein the search results are indicative of the driver account for the driver. The driver account may comprise credits that can be provided to the parking provider in exchange for parking in the parking area.

Subsequently, it is contemplated that the driver returns to the vehicle, causes the vehicle to be placed in an operational state, and causes the vehicle to exit the parking area. The driver computing device can be configured to automatically detect that the vehicle has exited the parking area without input by the driver using the geo-motion detection components of the driver computing device. In an example, the driver computing device may determine that the vehicle has exited the parking area using a motion coprocessor and an accelerometer described above. In another example, the driver computing device may determine that the vehicle has exited the parking area using an assisted GPS receiver. Responsive to determining that the vehicle has exited the parking area, the driver computing device transmits a second notification to the server computing device, wherein the second notification indicates that the vehicle has exited the parking area.

Responsive to receiving the second notification, the server computing device may record a second date-time, wherein the second date-time is reflective of a date and time at which the vehicle exited the parking area. The server computing device may additionally mark the set of geolocation coordinates (i.e., the parking area) retained in the data store as unoccupied so that other vehicles may be routed to the parking area as the parking area is now unoccupied.

The server computing device then calculates an amount of credits that are to be deducted from the driver account and credited to the parking provider account. The amount may be based on a flat rate, an hourly rate, or a differential pricing rate calculated based upon available parking areas in an area near the parking area.

Responsive to calculating the amount of credits that are to be charged, the server parking application causes the amount of credits from the credits in the driver account to be transferred electronically from the driver account to the parking provider account.

The above-described technologies present various advantages over conventional parking related technologies. First, unlike conventional parking technologies, the above described parking application enables parking providers to define individual parking areas using assisted GPS technology (as well as other geo-motion detection components), which is not possible solely using conventional GPS technology that is only accurate to within 4-6 m. The parking application enables a parking provider to change the location and dimensions of these individual parking areas to fit his or her needs. For instance, if long-term parking is required that will not require frequent access to parked vehicles, the parking application may be utilized by the parking provider to maximize space in a parking lot by defining parking areas in close proximity to one another. On the other hand, if frequent access to parked cars is required, the parking application may be utilized by the parking provider to define parking areas that are spaced farther apart so as to facilitate speedy access to vehicles parked in the parking areas. Second, as the parking application described herein may be used to define individual spaces, it may be used by commercial parking providers (e.g., operators of parking lots), as well as smaller-scale parking providers, such as an individual providing a portion of his or her driveway or yard for use as a parking area or a business with extra space that could be used as a parking area.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an exemplary computing system that facilitates defining and providing access to a parking area.

FIG. 2 is a functional block diagram of an exemplary server parking application.

FIG. 3 is a functional block diagram of an exemplary parking provider computing device.

FIG. 4 is a functional block diagram of an exemplary parking provider application.

FIG. 5 is a functional block diagram of an exemplary driver computing device.

FIG. 6 is a functional block diagram of an exemplary driver parking application.

FIG. 7 is a block diagram of a parking lot including parking areas.

FIG. 8 is a flow diagram that illustrates an exemplary methodology executed by a server computing device for defining and providing access to a parking area.

FIG. 9 is a flow diagram that illustrates an exemplary methodology executed by a parking provider computing device that facilitates defining a parking area.

FIG. 10 is a flow diagram that illustrates an exemplary methodology executed by a driver computing device that facilitates parking in a parking area.

FIG. 11 is an exemplary computing system.

### DETAILED DESCRIPTION

Various technologies pertaining to defining a parking area and providing access to a parking area are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

As used herein, the term “vehicle” refers to a device that transports one or more persons and/or goods over land. For example, and not by way of limitation, the term vehicle may encompass cars, trucks, motorcycles, bicycles, recreational vehicles, and/or buses. The term vehicle is meant to encompass traditional vehicles that are operated by a driver, as well as autonomous vehicles (i.e., self-driving) that are capable of observing their environment and navigating without human input. Furthermore, as used herein, the term “driver” is meant to encompass traditional operators of vehicles, as well as passengers of vehicles (including passengers of autonomous vehicles). In certain embodiments, the term “driver” may refer to the autonomous vehicle itself. Additionally, as used herein, the term “parking area” is meant to encompass parking spaces, parking lots, and/or parking garages.

As used herein, the term “accuracy” when used in reference to measurements made by geo-motion detection components (such as GPS and assisted GPS), refers to a difference between a measurement reported by geo-motion detection components and an actual location of the geo-motion detection components up to a specified confidence threshold. For instance, if a GPS receiver is accurate to within 10 meters, this means that the measurement produced by the GPS receiver will differ from the actual location of the GPS receiver by no more than 10 meters 95% of the time.

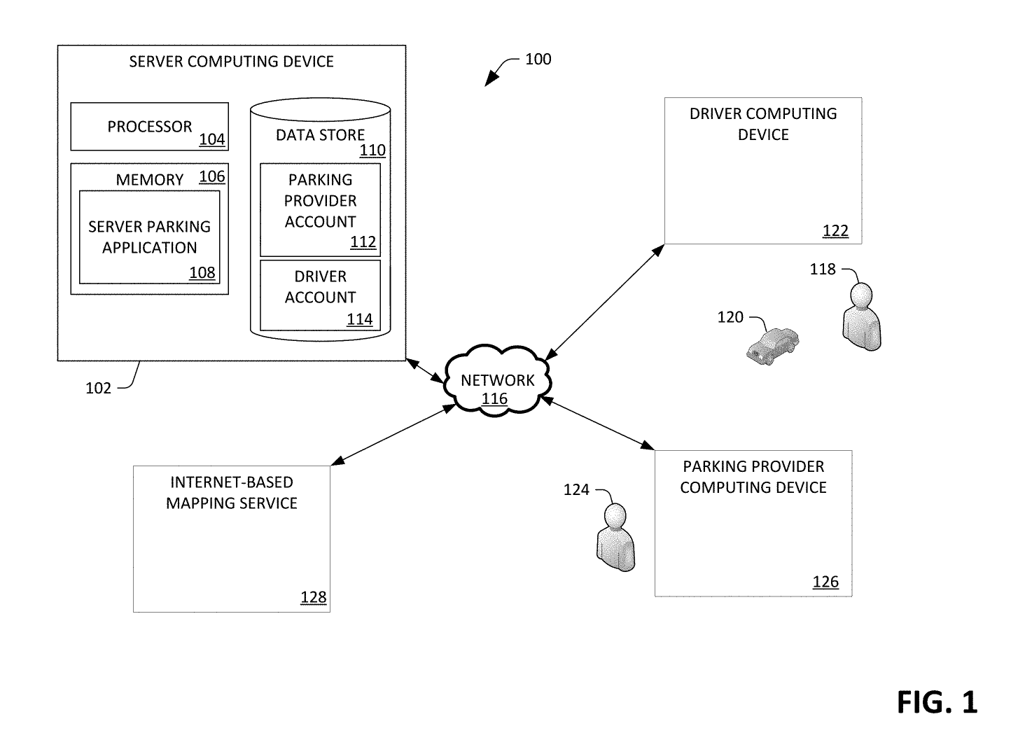

With reference to FIG. 1, an exemplary computing system 100 that facilitates defining a parking area and providing access to the parking area is illustrated. The computing system 100 includes a server computing device 102. The server computing device 102 comprises a processor 104 and memory 106, wherein the memory 106 has a server parking application 108 loaded therein. As will be described in greater detail below, the server parking application 108 is configured to receive a set of geolocation coordinates defining a parking area. The server parking application 108 is also configured to receive notifications that a vehicle has entered and exited the parking area. The server parking application 108 is further configured to facilitate payment for parking in the parking area.

The server computing device 102 additionally comprises a data store 110 retaining a parking provider account 112 and a driver account 114. The parking provider account 112 may include an identifier for a parking provider 124, demographic information for the parking provider 124, contact information for the parking provider 124, information related to receiving payment for providing parking areas (e.g., bank account information, Internet-based payment platform account information, etc.), payment configuration data (e.g., flat-fee, hourly, differential, etc.), sets of geolocation coordinates defining parking areas under control of the parking provider 124, status information with respect to the parking areas (e.g., occupied/unoccupied, activated/deactivated), and/or a transaction history for parking areas under the control of the parking provider 124.

The driver account 114 may include one or more identifiers (e.g., name, driver's license number, etc.) for a driver 118, demographic information for the driver 118, contact information for the driver 118, information relating to a vehicle 120 of the driver 118 (e.g., manufacturer, model, year, color, license plate number, etc.), payment information (e.g., credit card information, Internet-based payment platform account information, etc.), credits that can be exchanged as compensation for being provided a parking area, and/or a parking transaction history for the driver 118.

While the data store 110 is depicted as storing a single parking provider account and a single driver account, it is to be understood that the data store 110 may store many parking provider accounts for many different parking providers, as well as many different driver accounts for different drivers. Additionally, while the data store 110 is depicted as storing both the parking provider account 112 and the driver account 114, it is understood that the parking provider account 112 and the driver account 114 may be retained in different data stores accessible to the server computing device 102.

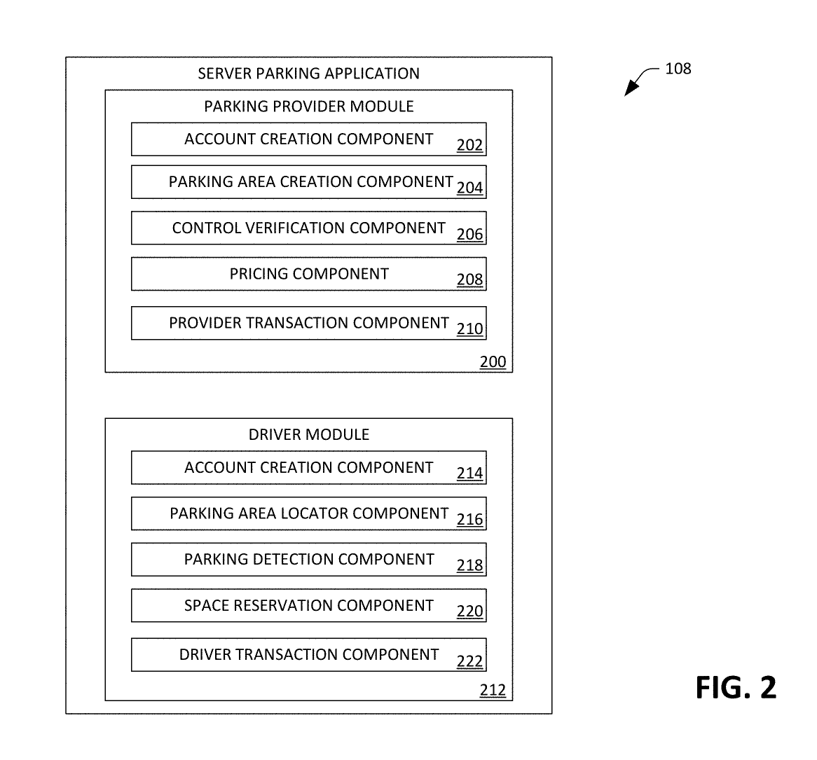

Referring briefly now to FIG. 2, a functional block diagram of the server parking application 108 is illustrated. The server parking application 108 provides functionality to the parking provider 124 via a parking provider module 200. The server parking application 108 also provides functionality to the driver 118 via the driver module 210.

The parking provider module 200 may include an account creation component 202, a space creation component 204, a control verification component 206, a pricing component 208, and/or a parking provider transaction component 210. The account creation component 202 is configured to create the parking provider account 112 based upon information for the parking provider 124 received from the parking provider computing device 126. The parking area creation component 204 is configured to receive a set of geolocation coordinates defining a parking area and an identifier for the parking provider 124 from the parking provider computing device 126 and to store the set of geolocation coordinates in association with the parking provider account 112 retained in the data store 110. The control verification component 206 is configured to ascertain whether the parking provider 124 has authority to use the area defined by the set of geolocation coordinates. The pricing component 208 is configured to determine an amount of credits that are to be charged for a parking area. For instance, the pricing component 208 may be configured to estimate demand for a parking area given certain factors (traffic congestion, time of day, date of the week, etc.) and to set a price for a parking area given the estimated demand. The parking provider transaction component 210 is configured to facilitate transferring credits from the driver account 114 to the parking provider account 112.

The driver module 212 may include an account creation component 214, a parking area locator component 216, a parking detection component 218, a space reservation component 220, and a driver transaction component 222. The account creation component 214 is configured to create the driver account 114 based upon information for the driver 118 received from the driver computing device 122. The parking area locator component 216 is configured to locate available parking areas for the vehicle 120 based upon current geolocation coordinates for the driver computing device 122 (and hence the vehicle 120). The parking detection component 218 is configured to receive a notification from the driver computing device 122 indicating that the vehicle 120 has entered or exited a parking area. The parking detection component 218 is also configured to identify the parking provider account 112 assigned to the parking area. The space reservation component 220 is configured to process reservations requests for parking areas received from the driver computing device 122. The driver transaction component 222 is configured to facilitate transfer of credits from the driver account 114 to the parking provider account 112.

Turning back to FIG. 1, the computing system 100 comprises a parking provider computing device 126 that is operated by a parking provider 124 (i.e., a person who provides a parking area). In a non-limiting example, the parking provider computing device 126 may be a mobile computing device, such as a tablet computing device, a smartphone, or a wearable computing device. The parking provider computing device 126 is in communication with the server computing device 102 by way of the network 116. The parking provider computing device 126 may also be in communication with an Internet-based mapping service 128 (described below).

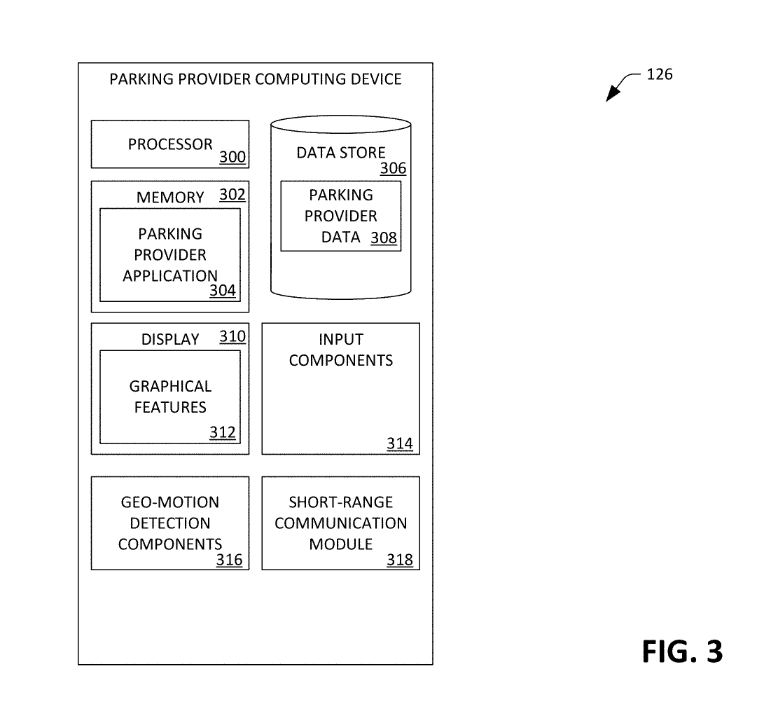

Referring now to FIG. 3, the parking provider computing device 126 comprises a processor 300 and memory 302, wherein the memory 302 has a parking provider application 304 loaded therein. As will be described in greater detail below, the parking provider application 304 is generally configured to define parking areas by way of geo-motion detection components 316 of the parking provider computing device 126. The parking provider application 304 is also configured to enable the parking provider 124 to create the parking provider account 112.

The parking provider computing device 126 may include a data store 306 comprising parking provider data 308, wherein the parking provider data 308 is a subset of the data in the parking provider account 112 retained in the data store 110 of the server computing device 102.

The parking provider computing device 126 may include a display 310, whereupon graphical features 312 may be presented thereon. For instance, a graphical user interface (GUI) for the parking provider application 304 may be presented as part of the graphical features 312. The parking provider computing device 126 may include input components 314 suitable for data input (e.g., touchscreen, mouse, keyboard, trackpad, trackwheel, video camera, microphone, etc.).

The parking provider computing device 126 may additionally include geo-motion detection components 316 and a short-range communication module 318. In general, the geo-motion detection components 316 include hardware and software components that can be used to determine a position of the parking provider computing device 126 and a velocity (i.e., speed and heading) of the parking provider computing device 126. In a non-limiting example, the geo-motion detection components 316 may include one or more of a global position system (GPS) receiver, an assisted GPS receiver, a gyroscope, an accelerometer, a barometer, an altimeter, a radio frequency transreceiver, a compass, or a motion coprocessor. When the geo-motion detection components 316 include an assisted GPS receiver, the assisted GPS receiver may have an accuracy of 1-50 cm, meaning that geolocation coordinates reported by the assisted GPS receiver differ from actual geolocation coordinates of the assisted GPS receiver no more than 1-50 cm 95% of the time. When the geo-motion detection components 316 include a motion coprocessor and an accelerometer and/or a gyroscope, the motion coprocessor may be configured to detect whether the parking provider computing device 126 is moving based upon data produced by the accelerometer or the gyroscope. The short-range communication module 318 may be a near field communication (NFC) receiver or a Bluetooth chip.

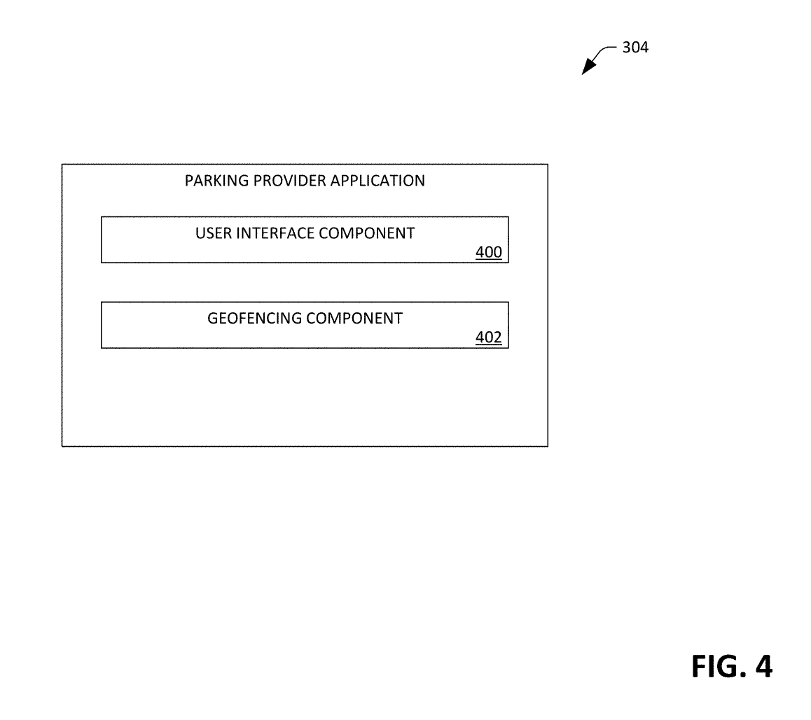

Referring briefly to FIG. 4, a functional block diagram of the parking provider application 304 is illustrated. The parking provider application 304 includes a user interface component 400 and a geofencing component 402. In general, the user interface component 400 is configured to enable the parking provider to 134 access functionality of the parking provider application 304. For instance, the user interface component 400 may be configured to present a GUI for the parking provider application 304 on the display 310 of the parking provider computing device 126. The user interface component 400 also facilitates the creation of the parking provider account 112. The geofencing component 402 is configured to enable the parking provider application 304 to define a parking area based upon data received by an assisted GPS receiver of the parking provider computing device 126.

Turning back to FIG. 1, the computing system 100 comprises a driver computing device 122 that is operated by a driver 118 (i.e., a person) that operates or is a passenger of a vehicle 120. In a non-limiting example, the driver computing device 122 may be a mobile computing device such as a tablet computing device, a smartphone, or a wearable computing device. The driver computing device 122 may also be a computing device that is integrated into the vehicle 120. The driver computing device 122 is in communication with the server computing device 102 by way of the network 116. The driver computing device 122 may also be in communication with the Internet-based mapping service 128 (described below) by way of the network 116.

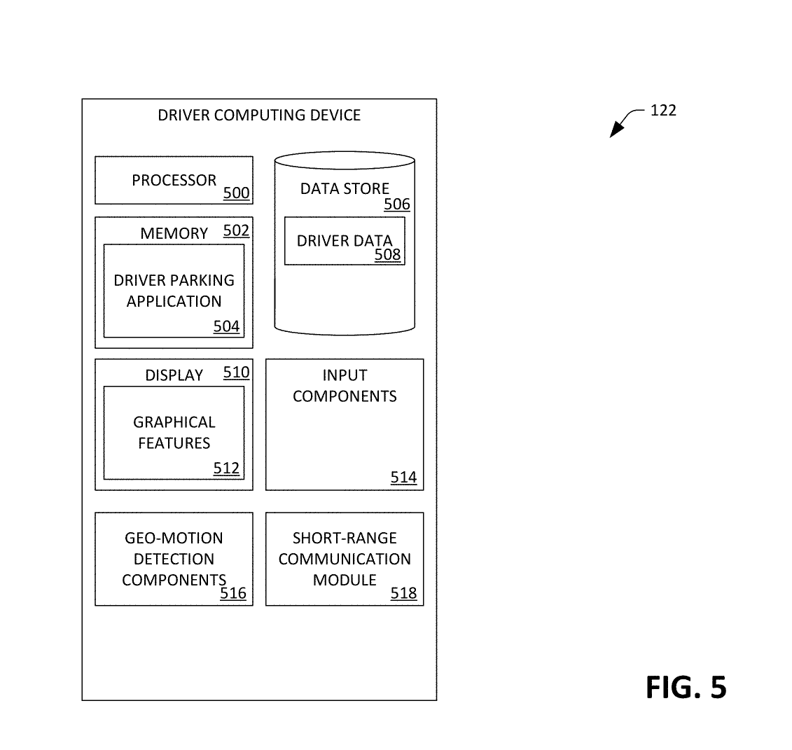

With reference now to FIG. 5, a functional block diagram of the driver computing device 122 is illustrated. The driver computing device 122 comprises a processor 500 and memory 502, wherein the memory 502 has a driver parking application 504 loaded therein. As will be described in greater detail below, the driver parking application 504 is generally configured to interface with the server parking application 108 in order to determine if the vehicle 120 has entered/exited a parking area defined by the parking provider computing device 126.

The driver computing device 122 may include a data store 506 comprising driver data 508, wherein the driver data 508 is a subset of the data in the driver account 114 retained in the data store 110 of the server computing device 102.

The driver computing device 122 may include a display 510, whereupon graphical features 512 may be presented thereon. For instance, a GUI for the driver parking application 504 may be presented as part of the graphical features 512. The driver computing device 122 may include input components 514 suitable for data input (e.g., touchscreen, mouse, keyboard, trackpad, trackwheel, video camera, microphone, etc.).

The driver computing device 122 may additionally include geo-motion detection components 516 (similar to those described above in the discussion of FIG. 3) and a short-range communication module 518. The geo-motion detection components 516 may include an assisted GPS receiver that has an accuracy of 1-50 cm. The short-range communication module 518 may be a near field communication (NFC) receiver or a Bluetooth chip. In an embodiment, the short-range communication module 518 may be employed by the driver computing device 122 to pair the driver computing device 122 with the vehicle 120. For instance, the vehicle may have a short-range communication module installed therein which can communication with the short-range communication module 518 in order to pair the driver computing device 122 and the vehicle 120. Thus, in the event that another person in the vehicle 120 also has the parking application installed on a computing device on his/her person, the driver parking application 504 can communication with the vehicle 120 in order to determine that the driver account for the driver 118 should be used and not the driver account for the other person. Alternatively, when more than one computing devices executing driver parking applications are available, the server parking application 108 can transmit messages to the more than one computing devices, and the computing device operated by the person who wishes to use his/her account may receive input causing the server parking application 108 to receive an indication as to which account is to be utilized.

The geo-motion detection components 516 may be configured to determine whether the vehicle 120 has transitioned from an operational state to a nonoperational state (or vice versa). For instance, the geo-motion detection components 516 may include an accelerometer and/or a gyroscope, as well as a motion coprocessor, and the motion coprocessor may be configured to detect whether the vehicle 120 is parked based upon data produced by the accelerometer and/or the gyroscope.

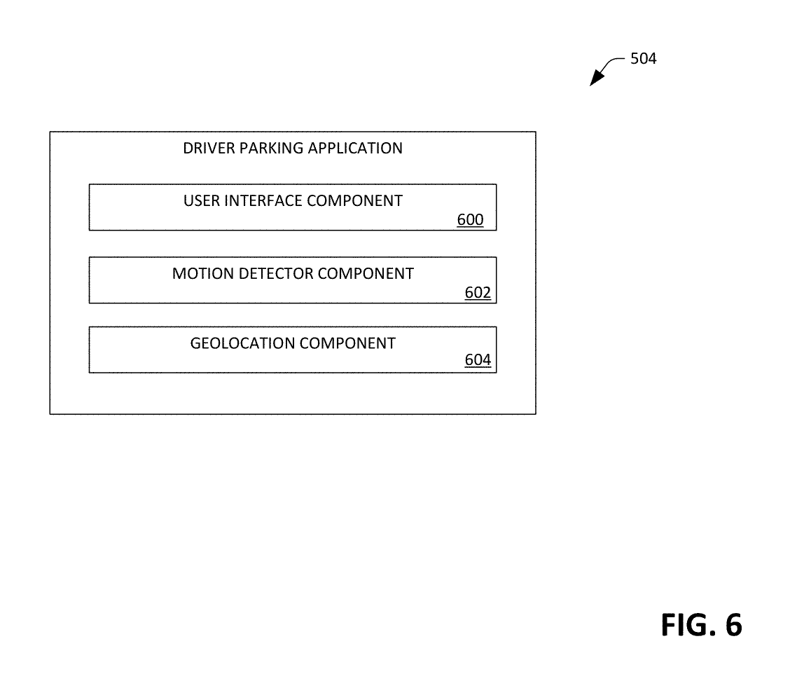

Turning now to FIG. 6, a functional block diagram of the driver parking application 504 is illustrated. The driver parking application 504 may include a user interface component 600, a motion detector component 602, and a geolocation component 604. In general, the user interface component 600 is configured to enable the driver 118 to access functionality of the driver parking application 504. For instance, the user interface component 600 may cause a GUI for the driver parking application 504 to be presented on the display 510. The user interface component also enables the driver 118 to create the driver account 114. The motion detector component 602 is generally configured to interface with the geo-motion detection components 516 in order to determine that the vehicle 120 has transitioned from an operational state to a nonoperational state or vice versa (i.e., has parked in the parking area or has exited the parking area). The motion detector component 602 is also configured to transmit notifications to the server parking application 108 indicating whether the vehicle 120 has transitioned from an operational state to a nonoperational state or vice versa. The geolocation component 604 is configured to interface with the geo-motion detection components 516 in order to determine geolocation coordinates for the driver computing device 122 (and hence the vehicle 120). The geolocation component 604 is further configured to transmit geolocation coordinates to the server parking application 108.

With reference again to FIG. 1, the computing system 100 may include an Internet-based mapping service 128. The Internet-based mapping service 128 is generally configured to generate directions from origin geolocation coordinates to destination geolocation coordinates, wherein the origin geolocation coordinates and the destination geolocation coordinates are received from the server parking application 108, the parking provider application 304, and/or the driver parking application 504. The Internet-based mapping service 128 may also be configured to ascertain addresses corresponding to an area in which a parking area (defined by a set of geolocation coordinates) is located.

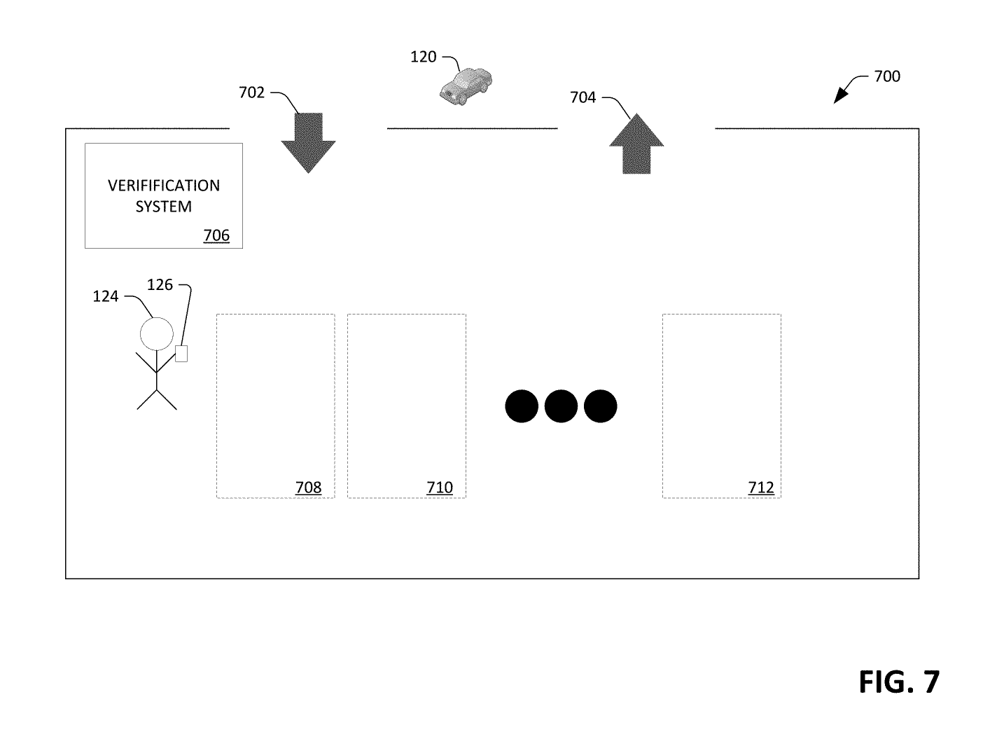

Turning now to FIG. 7, an exemplary parking area 700 is illustrated. In an example, the parking area 700 may be a commercial parking lot. In another example, the parking area 700 may be part of a driveway or yard of the parking provider 124. The parking area 700 includes an entrance 702 whereby the vehicle 120 can enter the parking area 700. The parking area 700 also includes an exit 704 whereby the vehicle 120 can exit the parking area 700. Although the entrance 702 and the exit 704 are depicted as being in separate locations, it is understood that the entrance 702 and the exist 704 may be in the same location.

The parking area 700 includes parking spaces 708-712 that have been defined using the parking provider application 304 executing on the parking provider computing device 126 operated by the parking provider 124.

In an embodiment, the parking area 700 may include a verification system 706. The verification system 706 may be in communication with the server parking application 108, the parking provider application 304, and/or the driver parking application 504 by way of the network 116. The verification system 706 may be tasked with ensuring that only authorized vehicles are allowed to enter the parking area 700. Thus, the verification system 706 may ensure that only vehicles operated by drivers using the parking application are allowed to enter the parking area 700. The verification system 706 may also be configured to notify a vehicle removal service (e.g., a towing company) in the event that an unauthorized vehicle parks in the parking spaces 708-712.

In an embodiment, the verification system 706 may be a computing device coupled to a mechanical gate in front of the entrance 702. When the driver computing device 122 comes within a pre-defined distance from the verification system 706, the driver parking application 504 can cause the driver computing device 122 to emit a signal (e.g., by way of the short-range communication module 518) causing the verification system 706 to open the mechanical gate, thereby allowing the vehicle 120 to enter the parking area 700.

In another embodiment, the verification system 706 may be a collection of cameras. The cameras may capture images of license plates of vehicles entering the parking area 700. The verification system 706 can transmit the images to the server parking application 108, and the server parking application 108 can determine whether the vehicles are in the parking area 700 are authorized (i.e., whether the drivers operating the vehicles have driver accounts).

Referring generally to FIGS. 1-7, operation of the computing system 100 is now set forth. It is contemplated that the parking provider 124 wishes to create a parking provider account in order to provide access to parking areas to drivers. As such, the parking provider application 304 may receive parking provider account data as input from the parking provider 124. For instance, the parking provider account data may include an identifier for a parking provider 124, demographic information for the parking provider 124, contact information for the parking provider 124, information related to receiving payment for providing parking areas (e.g., bank account information, Internet-based payment platform account information, etc.), and payment configuration data (e.g., flat-fee, hourly, differential, etc.). The parking provider application 304 may then transmit the parking provider account data to the server parking application 108, whereupon the server parking application 108 can create the parking provider account 112 based upon the parking provider account data.

It is also contemplated that the driver 118 wishes to create a driver account in order to be authorized to park the vehicle 120 in the parking area. As such, the driver parking application 504 may receive driver account data as input from the driver 118. For instance, the driver account data may include one or more identifiers (e.g., name, driver license number, etc.) for the driver 118, demographic information for the driver 118, contact information for the driver 118, information relating to the vehicle 120 of the driver 118 (e.g., manufacturer, model, year, color, license plate number, etc.), and/or payment information (e.g., credit card information, Internet-based payment platform account information, etc.). The driver parking application 504 may then transmit the driver account data to the server parking application 108, whereupon the server parking application 108 can create the driver account 114 based upon the driver account data.

Subsequently, the parking provider computing device 126 may be employed by the parking provider 124 to define a parking area. The parking area may be part of a commercial parking lot or garage, part of a driveway or yard of the parking provider 124, or a street-parking area. The parking area may have dimensions designed to accommodate different vehicle types (e.g., car, truck, motorcycle, bus, recreational vehicle, bicycle, etc.).

In a first embodiment, the parking provider application 304 may receive an indication that a parking area is to be defined from the parking provider 124. Responsive to receiving the indication, the parking provider application 304 may activate the geo-motion detection components 316 (e.g., an assisted GPS receiver) of the parking provider computing device 126, and the assisted GPS receiver can begin to receive geolocation coordinates from GPS satellites.

In the first embodiment, the parking provider 124 may then walk along boundaries of an area that is to be parking area, causing the parking provider application 304 to ascertain a set of geolocation coordinates for the parking area. For instance, the parking area may be rectangular, and the set of geolocation coordinates may include first geolocation coordinates for a first corner of the parking area, second geolocation coordinates for a second corner of the parking area, third geolocation coordinates for a third corner of the parking area, and fourth geolocation coordinates for a fourth corner of the parking area.

In a second embodiment, the parking provider application 304 may interface with the Internet-based mapping service 128 in order to present a map of an area around the parking provider computing device 126. For instance, the geo-motion detection components 316 may include an assisted GPS receiver that ascertains geolocation coordinates for the parking provider computing device 126. The parking provider computing device 126 can then transmit the geolocation coordinates to the Internet-based mapping service 128, and the Internet-based mapping service 128 can retrieve an electronic map of the area encompassing the geolocation coordinates based upon the geolocation coordinates. Alternatively, the Internet-based mapping service 128 can retrieve a satellite image of the area encompassing the geolocation coordinates based upon the geolocation coordinates. The Internet-based mapping service 128 can then transmit the map (or the satellite image) to the parking provider computing device 126, whereupon the parking provider application 304 can present the map (or the satellite image) on the display 310.

In the second embodiment, the parking provider computing device 126 may then receive input from the parking provider 124 causing the set of geolocation coordinates defining the parking area to be ascertained by the parking provider application 304. For instance, a pin may be presented on the display 310 (which may be a touchscreen), and the parking provider 124 may drag the pin to a location on the map (or the satellite image) shown on the display 310. The parking provider application 304 may then ascertain the set of geolocation coordinates for the parking area based upon the location of the pin on the map (or the satellite image). For instance, parking provider application 304 may calculate a rectangular area having the geolocation coordinates indicated by the pin located centrally therein, and the set of geolocation coordinates may correspond to corners of the rectangular area.

Optionally, the parking provider 124 may then cause a visual marker to be placed around the parking area defined by the set of geolocation coordinates. For instance, the parking provider 124 may paint the edges of the parking area with paint so as to visually indicate the location of the parking area. The parking provider 124 may also construct a sign indicating that a parking area is available, and place the sign near the parking area.

Prior to, concurrently with, or subsequent to ascertaining the set of geolocation coordinates defining the parking area, the parking provider application 304 may also receive input from the parking provider 124 indicative of an amount of credits that are to be charged to the driver 118 for parking the vehicle 120 in the parking area. In one example, the input may indicate a rate to be charged based upon a length of time a vehicle 120 remains parked in the parking area (e.g., hourly, daily, etc.). In another example, the input may indicate a flat-fee that is to be charged. In yet another example, the input may indicate that a differential price model is to be used, wherein the differential price model estimates demand for the parking area based on other available parking areas near the parking area, and sets the amount of credits based on the demand.

Subsequent to ascertaining the set of geolocation coordinates defining the parking area, the parking provider application 304 may transmit the set of geolocation coordinates and an identifier for the parking provider 124 to the server parking application 108.

Responsive to receiving the set of geolocation coordinates defining the parking area and the identifier for the parking provider 124, the server parking application 108 may identify the parking provider account 112 by executing a search based upon the identifier for the parking provider 124. The search produces search results, wherein the search results are indicative of the parking provider account 112. The server parking application 108 may then cause the set of geolocation coordinates (and optionally, an indication of the amount of credits that are to be charged) to be stored in association with the parking provider account 112 in the data store 110.

The server parking application 108 may also verify that the parking provider 124 has control of the parking area (i.e., that the parking provider 124 is authorized to rent out the area defining the parking area). For instance, the server parking application 108 may receive a proof of control document from the parking provider computing device 126. In an example, the proof of control document may be a utility bill for the parking provider 124 that includes an address of an area in which the set of geolocation coordinates defining the parking area is within. The server parking application 108 may then cause an address corresponding to the set of geolocation coordinates to be ascertained by way of the Internet-based mapping service 128. When the address in the proof of control document matches the address ascertained by the Internet-based mapping service 128, the server parking application 108 can store the set of geolocation coordinates defining the parking area in association with parking provider account 112. When the address in the proof of control document does not match the address ascertained by the Internet-based mapping service 128, the server parking application 108 can transmit a message to the parking provider application 304 indicating that the parking provider 124 does not have authority to rent the parking area.

Sometime thereafter, it is contemplated that the driver 118 is operating the vehicle 120 and that driver 118 has decided to park the vehicle 120.

In an embodiment, the driver computing device 122 may receive input from the driver 118 causing the driver computing device 122 to transmit a request for an available parking area to the server parking application 108. The request comprises geolocation coordinates (i.e., a latitude and longitude measurement pair) reflecting a current position of the vehicle 120. The driver computing device 122 may ascertain the geolocation coordinates for the current position of the vehicle 120 using the geo-motion detection components 516 comprised by the driver computing device 122. Responsive to receiving the request from the driver computing device 122, the server parking application 108 may identify the (above-referenced) parking area based upon the geolocation coordinates and the set of geolocation coordinates retained in the data store 110. The server parking application 108 can cause the parking area to have a status of reserved such that in the event that a second request is received from another driver computing device, the server parking application 108 will not identify the parking area as being available. The server parking application 108 may then cause the driver parking application 504 to receive directions from the current position of the vehicle 120 to the parking area (e.g., via the Internet-based mapping service 128).

In another embodiment, the server parking application 108 may be configured to identify parking areas that have previously been available for parking, but are not currently available for parking. In the embodiment, the server parking application 108 can transmit data to driver parking application 504 causing a map to be presented on the display 510 of the driver computing device 122, wherein the map includes visual indications of the parking areas that have previously been offered for parking. For instance, currently available parking areas may be shown in a first color on the display 510, and parking areas that have been previously been offered for parking (but are not currently offered) may be shown in a second color on the display 510. In an example, the driver computing device 122 can receive a selection of a parking area in the parking areas, and the driver parking application 504 can transmit a set of geolocation coordinates corresponding to the parking area to the server parking application 108. The server parking application 108 may then identify a parking provider account (and hence, a parking provider) corresponding to the parking area. Responsive to identifying the parking provider account, the server parking application 108 may transmit a notification to a parking provider computing device of the parking provider of the parking area that the (currently unavailable) parking space has been requested. In an example, the parking provider computing device can receive input indicating that the parking provider wishes to make the (currently unavailable) parking area available. The parking provider computing device can transmit data based upon the input to the server parking application 108. Responsive to receiving the data, the server parking application 108 may mark the parking area as available.

In yet another embodiment, the parking application may be configured to reserve the parking area sometime in advance of when the driver 118 will park the vehicle 120. In the embodiment, the driver parking application 504 can receive reservation information as input from the driver 118. The reservation information includes a location for which a nearby parking area is requested and a date on which the parking area is requested. The reservation information may also include a length of time that the parking area is to be utilized. The driver parking application 504 may transmit the reservation information to the server parking application 108. Responsive to receiving the reservation information, the server parking application 108 may identify a parking area that is available for the date and the length of time specified in the reservation information. The server parking application 108 may then cause the parking area to be marked as reserved for the date and the length of time. Thus, in the event that a second request is received from another driver computing device, the server parking application 108 will not identify the parking area as being available.

The driver 118 then causes the vehicle 120 to be driven to the parking area. The vehicle 120 may arrive at the parking area. The driver 118 may then cause the vehicle 120 to transition from an operational state to a non-operational state in the parking area. The driver parking application 504 may then determine that the vehicle 120 has been parked based upon data produced or received by the geo-motion detection components 516. For instance, in an embodiment, the driver parking application 504 may employ a motion coprocessor and an accelerometer to detect a transition of the vehicle 120 from an operational state to a nonoperational state.

Responsive to determining that the vehicle 120 has transitioned from the operational state to the nonoperational state, the driver parking application 504 may ascertain geolocation coordinates for the driver computing device 122 (and hence the vehicle 120) using the geo-motion detection components 516. Responsive to ascertaining the geolocation coordinates, the driver parking application 504 transmits a first notification to the server parking application 108. The first notification comprises the geolocation coordinates and an identifier for the driver 118.

Responsive to receiving the first notification, the server parking application 108 identifies the parking provider account 112 based upon the geolocation coordinates and the set of geolocation coordinates defining the parking area. More specifically, the server parking application 108 determines that the geolocation coordinates received from the driver computing device 122 fall within the set of geolocation coordinates retained as part of the parking provider account 112. The server parking application 108 may mark a status of the parking area as “occupied” such that the server parking application 108 does not route other vehicles to the parking area while the vehicle 120 occupies the parking area.

The server parking application 108 identifies the driver account 114 based upon the identifier for the driver 118. More specifically, the server parking application 108 may execute a search over the data store 110 based upon the identifier for the driver 118. The search generates search results, wherein the search results are indicative of the driver account 114.

Sometime after the vehicle 120 is parked, the driver 118 may return to the vehicle 120 and cause the vehicle 120 to be placed in an operational state. Responsive to the vehicle 120 being placed in the operational state, the driver parking application 504 ascertains that the vehicle 120 has exited the parking area based upon data produced or received by the geo-motion detection components 516. In an example, the driver parking application 504 may employ a motion coprocessor and an accelerometer to detect a transition of the vehicle 120 from an operational to a nonoperational state. The driver parking application 504 may also employ an assisted GPS receiver to ascertain that the vehicle 120 has exited the parking area. For instance, the driver parking application 504 may continually track the location of driver 118 and may determine that the driver 118 has returned to the vehicle 120 after the first notification has been transmitted to the server parking application 108.

Responsive to determining that the vehicle 120 has exited the parking area, the driver computing device 122 can transmit a second notification to the server parking application 108 indicating that the vehicle 120 has exited the parking area. The second notification may include the identifier for the driver 118.

Responsive to receiving the second notification from the driver computing device 122, the server parking application 108 may calculate an amount of credits that are to be charged to the driver account 114 for parking the vehicle 120 in the parking area. The server parking application 108 may also record a second date time in order to determine a length of time that the vehicle 120 remained parked. For instance, the amount may be calculated as a function of time that the vehicle 120 remained in the parking area, the amount may be a predefined flat rate specified by the parking provider 124, or the amount may be calculated based upon available parking areas near the parking area. The server parking application 108 may also cause a status of the parking area to be changed to “unoccupied” such that the parking area may be utilized by other drivers.

Responsive to calculating the amount, the server parking application 108 can cause the amount of credits to be deducted from the driver account 114 and transferred to the parking provider account 112.

While the client-side functionality has been described as being accomplished via two separate applications (the parking provider application 304 and the driver parking application 504), it is understood that such functionality may be incorporated into a single client application that can be utilized both by the parking provider 124 and the driver 118.

Additionally, while the above-described process has been described as utilizing a single parking area, it is to be understood that the parking application described herein can be used to define and provide access to many parking areas. Moreover, parking areas defined using the above-described process may have different cost (i.e., amounts of credits) associated therewith. For instance, a first parking area that is in a desirable location (e.g., near an entrance to a street) may be assigned a higher amount of credits than a second parking area that is in a less desirable location (e.g., far from an entrance to the street).

It is also to be understood that parking areas defined using the above-described processes may be deactivated and re-defined in order to suit needs of the parking provider 124. In an example, when frequent access to parking areas is needed, the parking application may be employed to define parking areas that are spaced in a manner that facilitates access to vehicles parked in the parking areas (i.e., the parking areas may be spaced far apart). When frequent access to the parking areas is not needed, the parking application may be employed by the parking provider 124 to define parking areas in close-proximity to one another so as to enable a greater number of vehicles to be stored in the same area. In another example, the parking application may be used to define parking areas of different dimensions to accommodate different vehicle sizes.

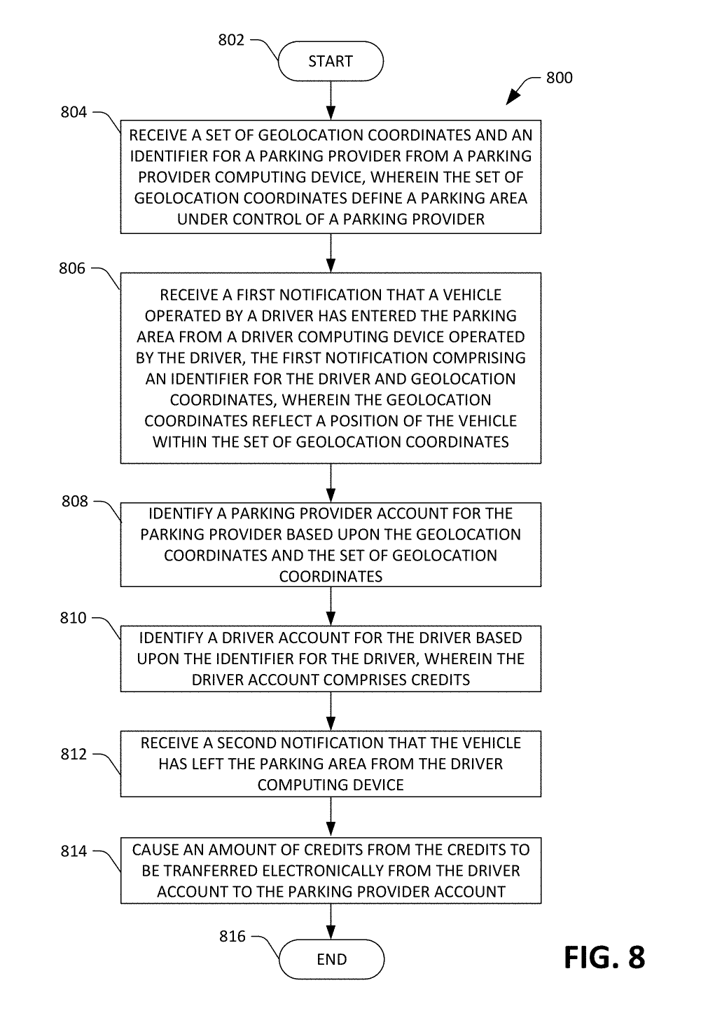

FIGS. 8-10 illustrate exemplary methodologies relating to defining and providing access to a parking area. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Turning now to FIG. 8, a methodology 800 executed by a server computing device that facilitates defining a parking area and providing access to the parking area is illustrated. The methodology 800 begins at 802, and at 804 the server computing device receives a set of geolocation coordinates and an identifier for a parking provider from a parking provider computing device operated by the parking provider. The set of geolocation coordinates define a parking area under control of the parking provider.

Subsequently, at 806, the server computing device receives a first notification that a vehicle operated by a driver has entered the parking area from a driver computing device of the driver. The first notification comprises an identifier for the driver and geolocation coordinates. The geolocation coordinates reflect a position of the vehicle within the set of geolocation coordinates (i.e., within the parking area defined by the set of geolocation coordinates).

At 808, the server computing device identifies a parking provider account for the parking provider based upon the geolocation coordinates received from the driver computing device and the set of geolocation coordinates received from the parking provider computing device. At 810, the server computing device identifies a driver account for the driver based upon the identifier for the driver. The driver account comprises credits that may be transferred to the parking provider in exchange for the parking provider providing the parking area to the driver.

Sometime thereafter, at 812, the server computing device receives a second notification from the driver computing device that the vehicle operated by the driver has exited the parking area. At 814, responsive to receiving the second notification, the server computing device causes an amount of credits from the credits in the driver account to be transferred to the parking provider account. The methodology 800 concludes at 816.

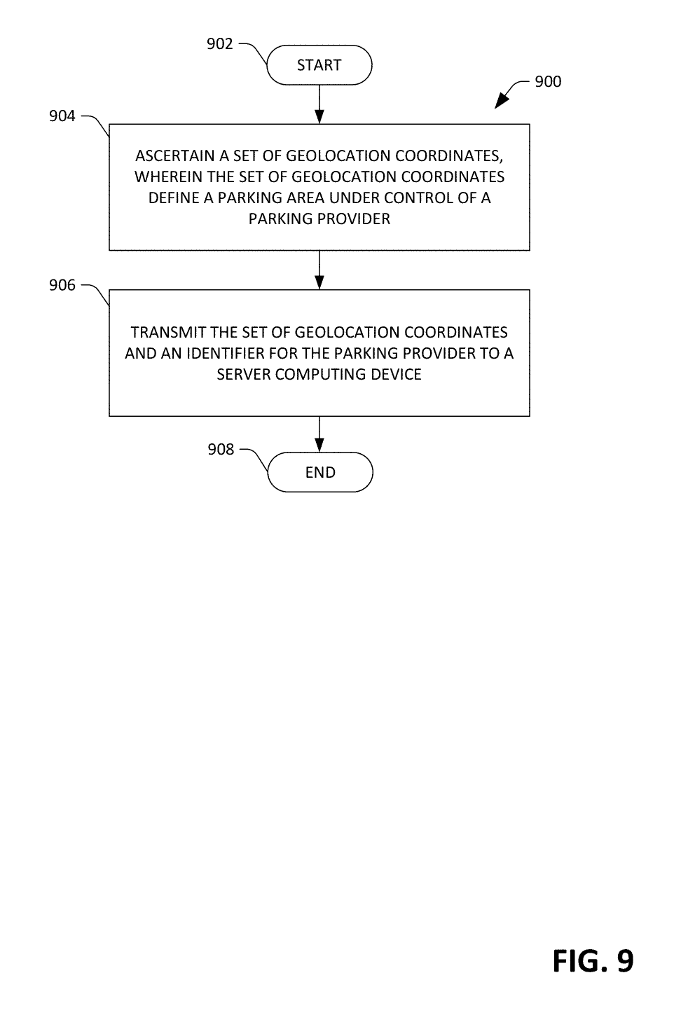

Referring now to FIG. 9, a methodology 900 executed by a parking provider computing device that facilitates defining a parking area is illustrated. The methodology 900 begins at 902, and at 904 the parking provider computing device ascertains a set of geolocation coordinates. The set of geolocation coordinates defines a parking area under control of a parking provider. At 906, the parking provider computing device transmits the set of geolocation coordinates and an identifier for the parking provider to a server computing device executing a server parking application, whereupon the server computing device identifies a parking provider account for the parking provider based upon the identifier for the parking provider and stores the set of geolocation coordinates in association with the parking provider account. The methodology 900 concludes at 908.

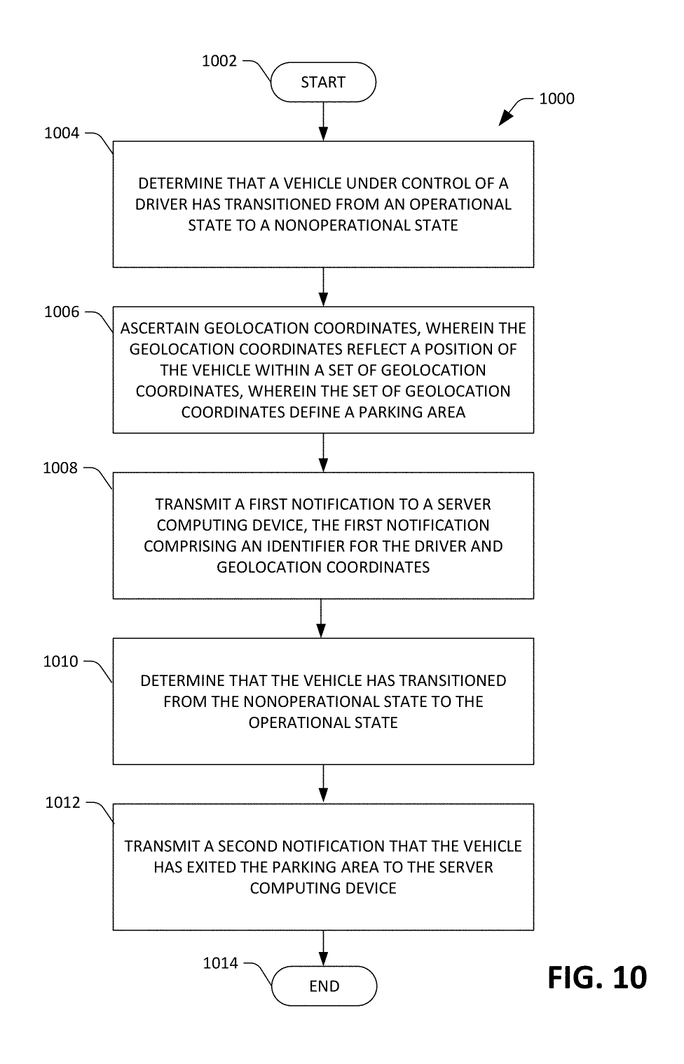

With reference to FIG. 10, a methodology 1000 executed by a driver computing device that facilitates parking in a parking area defined by a parking provider is illustrated. The methodology 1000 begins at 1002, and at 1004 the driver computing device determines that a vehicle operated by the driver has transitioned from an operational state to a nonoperational state (i.e., has parked). At 1006, responsive to determining that the vehicle has transitioned to a nonoperational state, the driver computing device ascertains geolocation coordinates for the vehicle. The geolocation coordinates reflect a position of the vehicle within a set of geolocation coordinates defining a parking area. At 1008, the driver computing device transmits a first notification to a server computing device executing a server parking application. The first notification comprises an identifier for the driver and the geolocation coordinates.

Subsequently, at 1010, the driver computing device determines that the vehicle has transitioned from the nonoperational state to the operational state (i.e., exited the parking area defined by the set of geolocation coordinates). Responsive to determining that the vehicle has exited the parking area, at 1012, the driver computing device transmits a second notification to the server computing device, the second notification indicating that the vehicle has exited the parking area. The second notification may include the identifier for the driver. The methodology 1000 concludes at 1014.

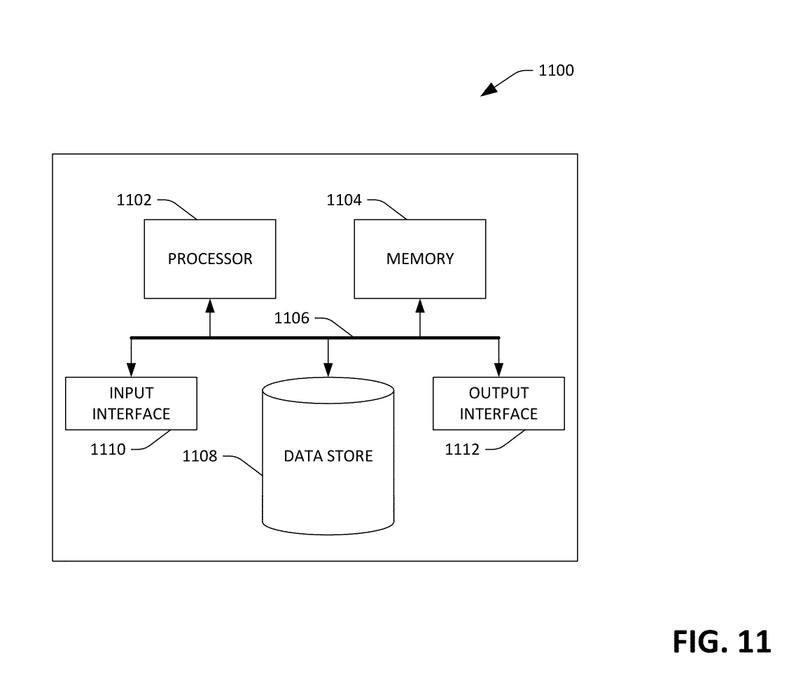

Referring now to FIG. 11, a high-level illustration of an exemplary computing device 1100 that can be used in accordance with the systems and methodologies disclosed herein is illustrated. For instance, the computing device 1100 may be used in a system that defines a parking area using assisted GPS technologies. By way of another example, the computing device 1100 can be used in a system that facilitates detection of a vehicle within a parking area defined using assisted GPS. The computing device 1100 includes at least one processor 1102 that executes instructions that are stored in a memory 1104. The instructions may be, for instance, instructions for implementing functionality described as being carried out by one or more components discussed above or instructions for implementing one or more of the methods described above. The processor 1102 may access the memory 1104 by way of a system bus 1106. In addition to storing executable instructions, the memory 1104 may also store driver accounts, parking provider accounts, geolocation coordinates, etc.

The computing device 1100 additionally includes a data store 1108 that is accessible by the processor 1102 by way of the system bus 1106. The data store 1108 may include executable instructions, driver accounts, parking provider accounts, geolocation coordinates, etc. The computing device 1100 also includes an input interface 1110 that allows external devices to communicate with the computing device 1100. For instance, the input interface 1110 may be used to receive instructions from an external computer device, from a user, etc. The computing device 1100 also includes an output interface 1112 that interfaces the computing device 1100 with one or more external devices. For example, the computing device 1100 may display text, images, etc. by way of the output interface 1112.

It is contemplated that the external devices that communicate with the computing device 1100 via the input interface 1110 and the output interface 1112 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1100 in a manner free from constraints imposed by input devices such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1100 may be a distributed system. Thus, for instance, several devices may be in communication by way of a network connection and may collectively perform tasks described as being performed by the computing device 1100.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Application Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

1. A server computing device comprising:
a processor; and
memory storing a server parking application, wherein the server parking application, when executed by the processor, is configured to perform acts comprising:
receiving a set of geolocation coordinates and an identifier for a parking provider from a first mobile computing device operated by a parking provider, the set of geolocation coordinates defining a parking area under control of the parking provider, wherein the first mobile computing device is in network communication with the server computing device;
receiving a first notification that a vehicle operated by a driver has entered the parking area from a second mobile computing device operated by the driver, the second mobile computing device being separate from the vehicle, the first notification comprising an identifier for the driver and geolocation coordinates, wherein the geolocation coordinates reflect a position of the vehicle within the set of geolocation coordinates, wherein the second mobile computing device is in network communication with the server computing device, wherein the second mobile computing device determines that the vehicle has transitioned from an operational state to a nonoperational state within the set of geolocation coordinates defining the parking area using first data generated by geo-motion detection components comprised by the second mobile computing device, thereby causing the second mobile computing device to transmit the first notification to the server computing device;
responsive to receiving the first notification, identifying a parking provider account for the parking provider based upon the geolocation coordinates and the set of geolocation coordinates defining the parking area;
identifying a driver account for the driver based upon the identifier for the driver, wherein the driver account comprises credits;
receiving a second notification that the vehicle has exited the parking area from the second mobile computing device, wherein the second mobile computing device determines that the vehicle has transitioned from the nonoperational state to the operational state within the set of geolocation coordinates defining the parking area using second data generated by the geo-motion detection components comprised by the second mobile computing device, thereby causing the second mobile computing device to transmit the second notification to the server computing device; and
causing an amount of credits from the credits to be transferred electronically from the driver account to the parking provider account.

2. The server computing device of claim 1, wherein the first mobile computing device ascertains the set of geolocation coordinates by way of geo-motion detection components comprised by the first mobile computing device, wherein the second mobile computing device ascertains the geolocation coordinates by way of the geo-motion detection components comprised by the second mobile computing device.

3. The server computing device of claim 1, the acts further comprising:
responsive to receiving the first notification that the vehicle operated by the driver has entered the parking area, marking the set of geolocation coordinates defining the parking area as occupied.

4. The server computing device of claim 1, the acts further comprising:
subsequent to receiving the set of geolocation coordinates and the identifier for the parking provider and prior to receiving the first notification that the vehicle operated by the driver has entered the parking area, causing the set of geolocation coordinates to be stored in association with the parking provider account in a data store comprised by the server computing device.

5. The server computing device of claim 1, the acts further comprising:
subsequent to receiving the set of geolocation coordinates and the identifier for the parking provider and prior to receiving the first notification that the vehicle operated by the driver has entered the parking area, receiving a request for available parking areas from the second mobile computing device, the request comprising second geolocation coordinates, wherein the second geolocation coordinates reflect a current position of the vehicle, wherein the current position of the vehicle is outside of the parking area;
responsive to receiving the request, identifying the parking area based upon the geolocation coordinates and the second geolocation coordinates; and
causing the second mobile computing device to receive directions from the current position to the parking area.

6. The server computing device of claim 1, the acts further comprising
subsequent to receiving the set of geolocation coordinates and the identifier for the parking provider and prior to receiving the first notification that the vehicle operated by the driver has entered the parking area, verifying that the parking area defined by the set of geolocation coordinates is under control of the parking provider.

7. The server computing device of claim 1, the acts further comprising:
responsive to receiving the second notification, calculating the amount of credits.

8. The server computing device of claim 7, wherein calculating the amount of credits is based upon a duration of time that the vehicle remained in the parking area.

9. (canceled)

10. The server computing device of claim 1, wherein the parking provider causes the first mobile computing device to be moved across outer boundaries of the parking area, thereby causing the first mobile computing device to ascertain the set of geolocation coordinates.

11. The server computing device of claim 1, the acts further comprising:
subsequent to causing the amount of credits from the credits to be transferred, transmitting a message to the second mobile computing device, wherein the message includes an indication of the amount of credits that were transferred from the driver account to the parking provider account.

12. A method executed by a processor of a server computing device while the server computing device executes a server parking application, the method comprising:
receiving a set of geolocation coordinates and an identifier for a parking provider from a first mobile computing device operated by a parking provider, the set of geolocation coordinates defining a parking area under control of the parking provider, wherein the first mobile computing device is in network communication with the server computing device;
receiving a first notification that a vehicle operated by a driver has entered the parking area from a second mobile computing device operated by the driver, the second mobile computing device being separate from the vehicle, the first notification comprising an identifier for the driver and geolocation coordinates, wherein the geolocation coordinates reflect a position of the vehicle within the set of geolocation coordinates, wherein the second mobile computing device is in network communication with the server computing device, wherein the second mobile computing device determines that the vehicle has transitioned from an operational state to a nonoperational state within the set of geolocation coordinates defining the parking area using first data generated by geo-motion detection components comprised by the second mobile computing device, thereby causing the second mobile computing device to transmit the first notification to the server computing device;
responsive to receiving the first notification, identifying a parking provider account for the parking provider based upon the geolocation coordinates and the set of geolocation coordinates defining the parking area;
identifying a driver account for the driver based upon the identifier for the driver, wherein the driver account comprises credits;
receiving a second notification that the vehicle has exited the parking area from the second mobile computing device, wherein the second mobile computing device determines that the vehicle has transitioned from the nonoperational state to the operational state within the set of geolocation coordinates defining the parking area using second data generated by the geo-motion detection components comprised by the second mobile computing device, thereby causing the second mobile computing device to transmit the second notification to the server computing device; and
causing an amount of credits from the credits to be transferred electronically from the driver account to the parking provider account.

13. The method of claim 12, further comprising:
subsequent to receiving the set of geolocation coordinates and the identifier for the parking provider and prior to receiving the first notification that the vehicle operated by the driver has entered the parking area, verifying that the parking area defined by the set of geolocation coordinates is under control of the parking provider.

14. (canceled)

15. The method of claim 12, wherein the first mobile computing device ascertains the set of geolocation coordinates by way of geo-motion detection components comprised by the first mobile computing device, wherein the second mobile computing device ascertains the geolocation coordinates by way of the geo-motion detection components comprised by the second mobile computing device.

16. The method of claim 12, wherein the first mobile computing device receives an indication of the amount of credits as input from the parking provider, the method further comprising:
prior to causing the amount of credits to be transferred from the driver account to the parking provider account, receiving the indication of the amount of credits from the first mobile computing device.

17-20. (canceled)

21. The method of claim 12, further comprising:
responsive to receiving the first notification that the vehicle operated by the driver has entered the parking area, marking the set of geolocation coordinates defining the parking area as occupied.

22. The method of claim 12, further comprising:
subsequent to causing the amount of credits from the credits to be transferred, transmitting a message to the second mobile computing device, wherein the message includes an indication of the amount of credits that were transferred from the driver account to the parking provider account.

23. A mobile computing device of a driver of a vehicle, the mobile computing device being separate from the vehicle, the mobile computing device comprising:
a processor;
geo-motion detection components; and
memory storing a driver parking application, wherein the driver parking application, when executed by the processor, is configured to perform acts comprising:
determining that the vehicle has transitioned from an operational state to a nonoperational state within a set of geolocation coordinates defining a parking area under control of a parking provider using first data generated by the geo-motion detection components;
transmitting a first notification to a server parking application executing on a server computing device that is in network communication with the mobile computing device, wherein the first notification comprises an identifier for the driver and geolocation coordinates, wherein the geolocation coordinates reflect a position of the vehicle within the set of geolocation coordinates;
determining that the vehicle has transitioned from a nonoperational state to an operational state within the set of geolocation coordinates defining the parking area using second data generated by the geo-motion detection components; and
transmitting a second notification to the server parking application, wherein the second notification indicates that the vehicle has exited the parking area, wherein the second notification causes the server parking application to transfer an amount of credits to be transferred electronic from a driver account of the driver to a parking provider account of the parking provider.

24. The mobile computing device of claim 23, wherein the geo-motion detection components include one or more of a global position system receiver, an assisted global position system receiver, a gyroscope, a magnetometer, an accelerometer, a barometer, an altimeter, a compass, a radio frequency transreceiver, or a motion coprocessor.

25. The mobile computing device of claim 23, wherein the set of geolocation coordinates defining the parking area are defined via a second mobile computing device operated by the parking provider.

26. The mobile computing device of claim 25, wherein the second mobile computing device ascertains the set of geolocation coordinates by way of second geo-motion detection components comprised by the second mobile computing device
